(19) United States
(12) Patent Application Publication
(10) Pub. No.: US 2004/0144718 A1
(43) Pub. Date: Jul. 29, 2004

(54) Process and plant for cleaning waste water

(76) Inventor: Manfred Rick, Lohmar (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/726,903

(22) Filed: Dec. 3, 2003

(30) Foreign Application Priority Data
Dec. 3, 2002 (EP) 02102674.5

(51) Int. Cl. C02F 3/30

(52) U.S. Cl. 210/605

(57) ABSTRACT

The invention relates to a process for the biological treatment of waste water in fixed-bed reactors. The process includes the steps of dividing the waste water (2) into two part streams (10, 11). In one part stream, the pollutants in the waste water are aerobically treated while in the other part stream the pollutants are anaerobically treated.

### BACKGROUND OF THE INVENTION

1. Field of the Invention

The invention relates to a process for the biological treatment of waste water in fixed-bed reactors. This involves dividing the waste water into two part streams. In one part stream the pollutants in the waste water are aerobically treated while in the other part stream the pollutants are anaerobically treated. The invention also relates to a plant which is suitable for carrying out the process described above.

2. Related Art

Waste waters in general, and also in particular industrial waste waters, can be generally polluted with a large number of organic compounds. Since the oxygen dissolved in the water is used up for the degradation or oxidation of these compounds, the waste waters must be cleaned before they are discharged into the sewerage system or into bodies of water. This usually takes place by means of biological treatment of the waste water. The step or steps during the cleaning of the waste water are also referred to as treatment stages. In this respect, various processes for the biological treatment of waste water are known and are described, for example, in ATV-Handbuch, page 312 et seq. (ATV handbook, 4th edition, published by Ernst & Sohn, 1997). For example, continuous processes for the biological treatment of waste water in a so-called bio-filter are known. Biofiltration systems operate in a way similar to sand filters. A tank is filled with a supporting material, on which the microorganisms can be taken up. These systems are therefore also known as fixed-bed reactors, since the supporting material is fixed in a reactor. Depending on the system, one or more tanks are arranged in parallel or one behind the other. The tanks are supplied with atmospheric oxygen to maintain the biological degradation process by the microorganisms. The waste water is pumped through the one or more tanks with the aid of a pump, with various processes existing in principle, as a result of whether the waste water is passed through the tank or tanks from the bottom to the top or from the top to the bottom. Introduction of the oxygen, for example by compressed air, also takes place either with or against the direction of flow. Processes with a fixed-bed reactor are generally suitable only for waste water without any coarse substances capable of forming a sediment. Therefore, pre-cleaning stages with coarse screening systems are usually required.

The biodegradable pollutant content in the waste water is registered by two cumulative parameters and the effectiveness of a biological treatment stage is measured by these parameters. The chemical oxygen demand (COD) of a waste water represents the consumption of dissolved oxygen in the waste water that is required for the oxidation of all the organic and inorganic compounds in the water, irrespective of whether they are biodegradable. The biological oxygen demand (BOD5) describes the oxygen demand of aerobic microorganisms required for the biological degradation of pollutants within 5 days. Both values are given as a concentration in the water in mg/l. The COD concentration in a water is naturally always higher than, or at least equal to, the BOD5 concentration, since the BOD5 is included in the COD.

The actual biological degradation of the pollutants begins in the supporting material of the fixed-bed reactor. The bacteria which are present, or possibly added, form around the supporting material a biocenosis, which comprises a slime matrix in which the bacteria or else higher organisms are incorporated (a so-called bio-film). With increasing age there are formed different generations of:microorganisms, which generally feed off the previous generations. It is important that the bacteria are embedded, and consequently fixed, in the slime matrix.

The waste water to be treated flows through the tank with the supporting material, that is the fixed-bed reactor. The biodegradable organic pollutants present in the waste water are taken up and degraded by the microorganisms incorporated in the slime matrix. This takes place by oxidation of the organic compounds, substantially to form CO₂ and H₂O. To make the oxidation possible, not only an adequate food supply but also, in particular, atmospheric oxygen must be provided. This process is referred to as aerobic degradation.

At the same time and in parallel there takes place a second process, in which, with the exclusion of oxygen, the oxidation of ammonium-nitrogen NH₄—N takes place to form nitrite and later—with oxygen again—to form nitrate. Only very few bacterial strains are capable of carrying out this process. The oxygen required for the nitrite oxidation is in this case removed by the bacteria from the CO₂ present in the water. In the oxidation of NH₄ to form NO₃, hydrogen H is released, which in turn leads to a lowering of the pH. The entire operation is referred to as anaerobic degradation or nitrification. Since nitrite is in principle toxic, subsequent further oxidation of nitrite to form nitrate, so-called denitrification, is required.

The effectiveness of a biologically operating fixed-bed reactor (fixed-bed bio-reactor) is substantially dependent on the following parameters:

food supply

oxygen supply

flow rate in the filter

dwell time in the filter.

The food supply in the filter is determined by the pollutants which are to be degraded. To ensure the cell build-up of the bacteria in the bio-film, other is required trace elements must also be present however, and may have to be added.

The oxygen demand is determined by the amount of pollutants and is introduced into the process as atmospheric oxygen.

Since the biomass in the fixed bed is immobile, how much in the way of nutrients and oxygen is transported to the bacteria depends on the flow rate. A low flow rate means low transport of nutrients and oxygen, and consequently a less dense population of the supporting material. Therefore, it is desirable to attain high flow rates.

This is at odds with the dwell time in the reactor. Under optimum boundary conditions, the biocenosis requires a certain time to degrade a pollutant burden. It is therefore desirable to attain as long a dwell time as possible, with at the same time a high flow rate. In the case of activated-sludge plants, this is accomplished by flow tanks of a meandering design.

In DE 42 40 064 there is a description of a process in which textile waste water is treated in a number of steps. For the biological cleaning, this involves introducing the waste water into an aerated clarification stage, filled with brown coal coke as a supporting material. After a dwell time of about 4-10 h, the water is then treated further. The disadvantage of this process is the long dwell time of the waste water in the treatment stage. Therefore, to achieve an effective degradation rate, large tank volumes are required. Furthermore, the pollutant degradation is performed aerobically and anaerobically in one process step.

For the treatment of waste water, it is known from DE 42 05 787 to subject this waste water initially to one or more aerobic treatment steps and finally to treat the waste water further in an anaerobic degradation stage. However, there is no provision for controlling or influencing this anaerobic treatment stage.

Against this background, it is the object of the present invention to develop a process for the biological treatment of waste water which makes possible a continuous aerobic and anaerobic degradation of the pollutants in the waste water by means which are as simple as possible, along with a low space requirement, and which is at the same time suitable for reacting rapidly to different degrees of contamination of the waste water.

### SUMMARY OF THE INVENTION

According to the invention, the stream of waste water (overall volumetric flow) is divided into two part streams. In this respect, the invention is based on the idea that the simultaneous performance of aerobic and anaerobic degradation processes in one reactor is possible, but that the aerobic and anaerobic degradation processes adversely affect each other.

For instance, the aerobic pollutant degradation proceeds better in the alkaline range, since the bio-film becomes thinner in an acid environment. On the other hand, as described above, the anaerobic pollutant degradation leads to an environment which becomes acidic, and consequently hinders aerobic pollutant degradation.

While the aerobic degradation proceeds better at high flow rates, because this ensures the transport of nutrients and oxygen, the anaerobic degradation takes place better at low flow rates, since the rate of reaction is very slow, dependent on the supply of CO₂.

Fixed-bed reactors are back-flushed in a known way when required. If the aerobic and anaerobic pollutant degradation proceeds in one reactor, the anaerobic areas are consequently destroyed during the back-flushing and must be re-formed after each back-flushing. This significantly reduces the rate of pollutant degradation.

The first part stream consequently flows through an aerobic biological treatment stage, while the second part stream flows through an anaerobic treatment stage, the two treatment stages preferably being formed as fixed-bed reactors. This division makes possible an optimum setting of the conditions for the respective treatment stage; for example, it is possible to set the already aforementioned pH separately for each treatment stage. It proves to be particularly advantageous also to be able to set or regulate the overall volumetric flow. This measure allows the optimum degradation conditions to be ensured at any time for both treatment stages.

In an advantageous refinement of the present invention, the second, anaerobically treated part stream of waste water is introduced together with the first—still untreated—part stream into the aerobic treatment stage. As a result, the aerobic treatment stage has two tasks. One is the degradation of organic pollutants and the other is to oxidize the toxic nitrite produced during the anaerobic treatment directly to form nitrate.

In a further advantageous refinement of the invention, the waste waters cleaned in the aerobic and anaerobic treatment stages are re-circulated to the respective treatment stage until the pollutant degradation has reached a certain limit value.

In a further preferred refinement of the invention, the anaerobically treated part stream of waste water is passed as before into the aerobic treatment stage for denitrification. After the aerobic treatment, the waste water stream is returned again for further treatment and, as above, divided again into two part streams, which in turn, as before, are fed to the two treatment stages. The repeated passing of the waste water through both treatment stages allows the pollutant degradation to be optimized.

In a further preferred refinement of the invention, a recipient tank is used for monitoring and controlling the waste water streams. The waste waters to be treated flow into this recipient tank. A pump delivers the waste water stream to the aerobic or anaerobic treatment stage or stages. The individual streams can in this case be adapted optimally to the required pollutant degradation conditions by means of corresponding valves. Here it is also possible, for example, for manual or automatic monitoring of the degradation processes to be meaningfully employed. In the case of circulatory processes, the already treated waste water is returned into the recipient tank. This measure allows particularly effective and uniform pollutant degradation to be achieved, since different pollutant concentrations can be buffered in the waste water to be treated.

The invention also relates to a plant for the biological treatment of waste water which is suitable for carrying out the processes described.

The invention is explained in more detail on the basis of the exemplary embodiment shown in the accompanying drawing, in which:

### BRIEF DESCRIPTION OF THE DRAWINGS

FIG. 1 shows a schematic diagram of a preferred configuration of the waste water cleaning system according to the invention.

### DETAILED DESCRIPTION OF THE PREFERRED EMBODIMENTS

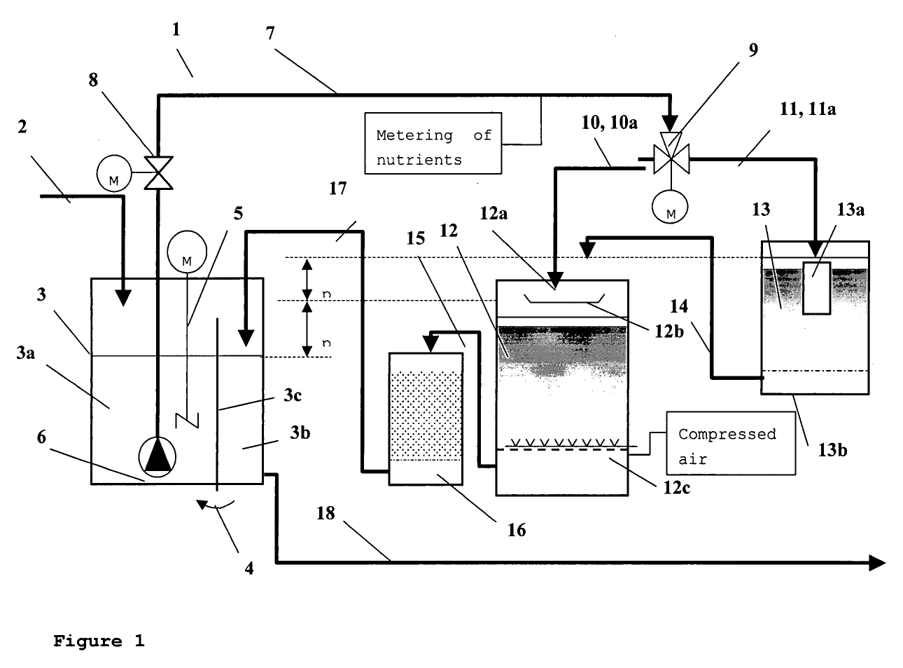

FIG. 1 shows a schematic drawing of the waste water cleaning plant 1 according to the invention. The waste water 2 to be treated is collected in a recipient tank 3. The recipient tank here comprises two chambers 3a, 3b with an associated dividing wall 3c. At the foot of the recipient tank 3 there is a connecting opening 4. The waste water is collected in the left-hand chamber 3a. An agitating mechanism 5 provides adequate mixing of the incoming untreated waste water 2 with the already partially cleaned waste water or the cleaned water flowing in through opening 4. By means of a pump 6, the water is pumped via a supply line 7 to the two treatment stages, an aerobic treatment stage 12 and an anaerobic treatment stage 13. In this case, the volumetric flow of the waste water can be set individually by means of an adjusting valve 8. In a way corresponding to the requirements of the treatment stages, nutrient solution, for example phosphoric acid, can be metered into the supply line 7. A distributor valve 9 divides the water into two part streams 10, 11, which reach the aerobic treatment stage 12 and the anaerobic treatment stage 13 respectively through associated supply lines 10a, 11a. The distributor valve 9 may be adjustable, and can consequently be set for example in a way corresponding to the burden of the water with ammonium. This may take place both manually and electrically, provided that there is a corresponding control device.

The part stream 11 introduced into the anaerobic stage 13 passes through a tank filled with a supporting material, on which the anaerobic bacteria can establish themselves. This is where the nitrification of the ammonium-nitrogen takes place with the exclusion of oxygen. The inlet 13a is configured in such a way that an inflow that is as free from turbulence as possible is ensured. The tank is provided with a screen deck 13b. At this point it is insignificant whether the throughflow of the waste water takes place from the top to the bottom or vice versa.

Downstream of the anaerobic stage 13, the water is introduced via the supply line 14 into the aerobic stage 12. Here it is aerobically treated together with the water from the part stream 10. The aerobic degradation stage 13 consequently performs two tasks: the part stream 10 arriving via the supply line 10a is aerobically treated (degradation of organic pollutants), and the anaerobic part stream from the supply line 14 is denitrified (oxidation of the nitrite to form nitrate). The aerobic degradation stage 12 is supplied with atmospheric oxygen from the bottom to the top. The waste water passes through the treatment stage 12 from the top to the bottom. Installed in the inflow 12a is a baffle plate 12b, to achieve uniform distribution of the water over the surface of the treatment stage 12. The tank is likewise provided with a screen deck 12c, through which the water can pass to be treated further.

Downstream of the aerobic stage 12, the water is introduced via the line 15 into a sand filter 16, where excess sludge from the aerobic treatment stage 12 is to be retained. From the sand filter 16, the water is then returned via line 17 into the recipient tank 3. Through the opening 4 in the dividing wall 3c, the treated water can flow again from the right-hand side of the chamber 3b to the left-hand side 3a and be returned for treatment by means of the pump 6. At the same time, on the right-hand side 3b of the recipient tank there is the outflow 18 for the treated cleaned water.

The two degradation stages 12, 13 and also the sand filter 16 are monitored by pressure gages, not shown here, and are back-flushed in a conventional way when permissible pressure values are exceeded.

The advantage of this process is that the flow rates in the two degradation stages 12, 13 can be set individually, irrespective of the inflowing amount of waste water 2. This makes an optimum loading density of the supporting material possible while minimizing the volume of the plant. The coordination between the adjusting valve 8 and the distributor valve 9 also allows the flow rate in the tanks of the aerobic and anaerobic treatment stages 12, 13 to be set differently.

As a result of the arrangement according to the invention, even changing volumetric flows or fluctuating pollutant burdens no longer have adverse effects on the treatment process, since the food supply is buffered in the recipient tank 3. As a result of the circulatory process, the flow rate in the two tanks of the treatment stages 12, 13 remains constant even when there are changing volumetric flows. Peaks in the pollutant burden are balanced out by the recipient tank 3.

As a result of the division into separate degradation stages 12, 13, adverse mutual influences are avoided. For instance, the lowering of the pH in the anaerobic stage 13 can be balanced out by a pH correction (not represented here) before the water goes into the aerobic stage 12.

The plant can be designed in such a way that the entire throughflow can be ensured with one pump 8. The control takes place by the setting of the differences in geodetic height between the tanks of the treatment stages 12, 13 and the sand filter 16. In this respect, the required pressure differences can be set by adjusting the inlet heights at the end of lines 14, 15 and 17.

What is claimed is:

1. A process for the biological treatment of waste waters, comprising dividing the waste waters into two part streams, a first part stream passing through an aerobic treatment stage and a second part stream passing through an anaerobic treatment stage.

2. The process for the biological treatment of waste waters as claimed in claim 1, wherein the ratio between the first and second part streams and/or the overall volumetric flow can be set and/or regulated.

3. The process for the biological cleaning of waste waters as claimed at least one of claim 2, wherein the second part stream, after passing the anaerobic treatment stage, is introduced together with the first part stream into the aerobic treatment stage.

4. The process for the biological cleaning of waste waters as claimed in claim 1, wherein the waste waters cleaned in the aerobic treatment stage and anaerobic treatment stage are re-circulated to the respective treatment stage.

5. The process for the biological cleaning of waste waters as claimed in claim 3, wherein, after passing the aerobic treatment stage, the waste water stream is re-circulated for further treatment.

6. The process for the biological cleaning of waste waters as claimed in claim 5, wherein at least one of the first or second treatment stages is preceded by a recipient tank.

7. A system for the biological treatment of waste waters, comprising:
a first a first part stream passing through an aerobic treatment stage and a second part stream passing through an anaerobic treatment stage, wherein the ratio between the first and second part streams and/or overall volumetric flow of the waste waters can be regulated.

8. A system as claimed in claim 7, further comprising: a recipient tank including two chambers with an associated dividing wall;
an agitating mechanism for mixing of the incoming untreated waste water into the recipient tank;
a pump for moving the waste waters to the aerobic treatment stage and the anaerobic treatment stage; and
a distributor valve for dividing the waste water into two part streams which reach the aerobic treatment stage and the anaerobic treatment stage respectively.
